(19) United States
(12) Patent Application Publication
(10) Pub. No.: US 2016/0267256 A1
(43) Pub. Date: Sep. 15, 2016

(54) DISEASE-SCREENING METHOD, MODULE AND COMPUTER PROGRAM, USING SAMPLES TAKEN FROM AN INDIVIDUAL

(71) Applicant: NOVACYT, Velizy Villacoublay (FR)

(72) Inventor: Eric PELTIER, Clamart (FR)

(21) Appl. No.: 15/028,701

(22) PCT Filed: Oct. 9, 2014
(86) PCT No.: PCT/EP2014/071702

§ 371 Date: Apr. 11, 2016

(30) Foreign Application Priority Data
Oct. 11, 2013 (FR) 13 59886

(51) Int. Cl. G06F 19/00

(52) U.S. Cl. CPC G06F 19/366; G06F 19/322; G06F 19/3418

(57) ABSTRACT

A method for screening diseases by sampling on an individual, said method being applied by a module for applying screening (2) and being characterizing that it comprises the following steps:
storing, in a data base (5) of said screening application module, of a set of data relating to an individual, said set of data comprising remote transmission coordinates relating to said individual, and additional data (AD) relating to said individual from among the age of the individual and/or data relating to the date and/or to the result of at least one previous screening relating to said individual and/or data relating to risk factors associated with said individual and/or data relating to a vaccination of said individual;
remotely transmitting, with said screening application module, to said remote transmission coordinates relating to said individual, a message for convening a subsequent screening to be carried out by said individual, said screening application module further determining, depending on at least said additional data relating to said individual, the contents of said convening message and/or the remote transmission instant of said convening message.

### FIELD OF THE INVENTION

The present invention relates to a disease-screening method using samples taken from an individual, this method being applied by a module for applying screening.

### BACKGROUND OF THE INVENTION

Organizing screening is often notably governed according to recommendations issued from learned medical societies. These recommendations are generally elaborated for the intention of public organizations, such as a health ministry which will then seek to raise awareness of screening in physicians and patients. These recommendations are then applied by the identified actors of the screening process.

A disease-screening process with sampling for example comprises the following operations:
an individual, hereafter called a “patient”, for example subsequent to a sensitization campaign, travels to a medical center (for example, in the case of screening for uterine cervix cancer, he/she travels to a gynecologist or to a laboratory);
a sample is taken from the patient (in the case of cervix cancer, a cervical smear picks up the cells to be analyzed);
the sample is sent to a laboratory which then carries out test(s) for screening the sought disease;
each test is analyzed so as to produce a result which may be interpreted as to either detection or not of the disease;
the result is sent to the physician and/or to the patient; if necessary, the patient then sees his/her physician for optional follow-ups.

The demonstration of the presence of certain pathologies lies on a redundancy of application of a screening test during the typical development period of the pathology in its early stage, both for compensating for the possibility of false negative results for the screening test (imperfect sensitivity), but also for following the patient during his/her life (notably within the scope of development of the disease).

For uterine cervix cancer, if the pathology is managed during the first ten years of its development (before the invasive stage), the remission rate is close to 100%. Screening every two to three years should theoretically give the possibility of detecting the pathology when the sensitivity of the test is of the order of 70%. The recommended scheme for screening uterine cervix cancer in France is for example the following up for a woman between 25 and 65 years old: two first screenings by cytological examination at an interval of one year, and then screening by cytological examination every 3 years.

Now, it is found that screening operations are not carried out in an optimal way. For example, in the case of screening of uterus cancer in France, it is seen that more than 50% of the women are not or too little often subjected to screening tests, while about 40% of the women undergo screening tests too frequently, and that only 10% of the women benefit from screening within the recommended interval (cf. “Etat des lieux et recommandations pour le dépistage du cancer du col de l'utérus en France”—(Situational analysis and recommendations for screening of uterine cervix cancer in France)—public health recommandations—July 2010: on the World-Wide-Web at: has-sante.fr/portaildcms/c_1009772/etat-des-lieux-et-recommandations-for-le-depistage-du-cancer-du-col-de-luterus-en-france).

For certain types of cancers, like prostate cancer, there does not exist any screening organization and general practitioners are the ones which decide or not for screening upon the visit of the patient, whereas for other cancers such as colon cancer and breast cancer, letters may be sent by an organization such as a health insurance for example, to targeted persons, informing them of their right to fully covered screening, accompanied with an explanatory note. These initiatives however are not found sufficient, alone.

### SUMMARY OF THE INVENTION

The present invention aims at improving the screening of diseases by samplings.

For this purpose, according to a first aspect, the invention proposes a method for screening disease(s) by sampling of the aforementioned type, characterized in that it comprises the following steps:
storing in a data base of said screening application module, a set of data relating to an individual, said set of data comprising remote transmission coordinates relating to said individual, and additional data relating to said individual from among the age of the individual and/or data relating to the date and/or to the result of at least one previous screening relating to said individual and/or data relating to risk factors associated with said individual and/or data relating to vaccination of said individual;
remote transmission by said screening application module, to said remote transmission coordinates relating to said individual, of a message for convening the individual to subsequent screening to be carried out by said individual, said screening application module further determining, depending on at least said additional data relating to said individual, the contents of said message and/or the remote transmission instant of said message.

The invention thus gives the possibility of improving the screening of diseases by sampling by organizing and customizing this screening.

In embodiments, the disease-screening method by sampling according to the invention further includes one or several of the following features:
said additional data comprise an indicator of the quality of a sample used for previous screening carried out by said individual;
said additional data comprise a confidence index associated with the result of a previous screening carried out by said individual;
the contents of said convening message is determined depending on the geographic localization of said individual;
at least one test to be conducted during said next screening is defined, by said screening application module, depending on at least said additional data relating to said individual;
said screening is screening of pre-cancer or cancer lesions of the morphological analysis type (cytology) or of a biological type (cell and molecular type).

According to a second aspect, the present invention proposes a disease-screening module by sampling on an individual, comprising
a data base adapted for storing a set of data relating to an individual and comprising remote transmission coordinates relating to said individual, and additional data relating to said individual from among the age of the individual and/or data relating to the date and/or to the result of at least one previous screening relating to said individual and/or data relating to risk factors associated with said individual and/or data relating to vaccination of said individual;
a remote transmission block suitable for remotely transmitting to the remote transmission coordinates relating to an individual and stored in the data base, a message for convening the individual to a next screening to be carried out by said individual, said module for applying screening being adapted in order to determine, depending on at least said additional data relating to said individual, the contents of said message and/or the remote transmission instant of said message.

According to a third aspect, the present invention proposes a computer program for screening disease(s) by sampling on an individual, said program including instructions for applying the steps of a method according to the first aspect of the invention during execution of the program by the processing means of said screening application module.

### BRIEF DESCRIPTION OF THE DRAWINGS

These features and advantages of the invention will become apparent upon reading the description which follows, only given as an example, and made with reference to the appended drawings, wherein:

FIG. 1 illustrates a system applying screening in an embodiment of the invention;

FIG. 2 is a flow chart of the steps of a method in an embodiment of the invention.

### DETAILED DESCRIPTION OF CERTAIN EMBODIMENTS OF THE INVENTION

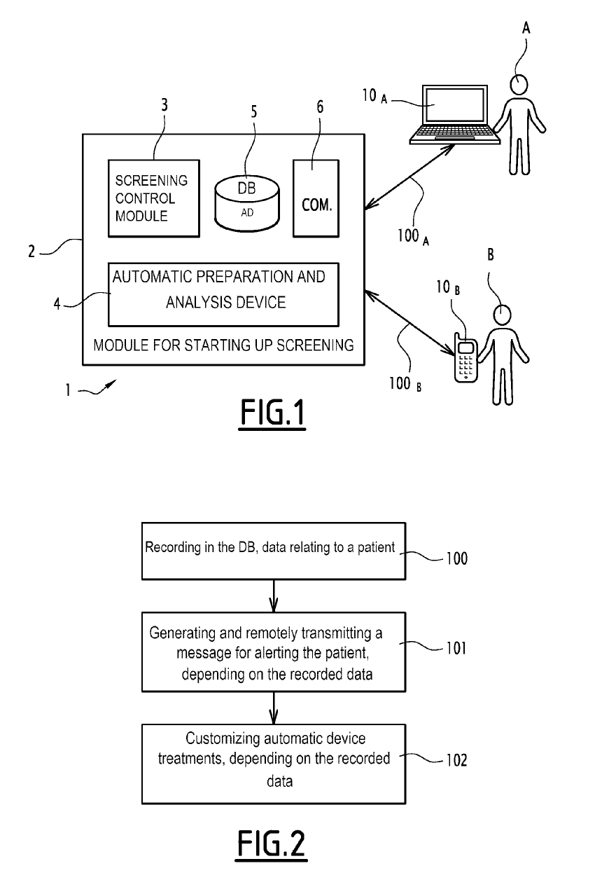

In an embodiment of the invention, a screening system 1 according to the invention is applied, comprising one or several modules for applying screening 2, similar to the one illustrated in FIG. 1.

The module for applying screening 2 in the relevant case comprises a module for controlling screening 3, an automatic device for preparation and analysis 4, a data base 5 and a communications interface 6.

These various elements of the module for applying screening may be grouped geographically, or on the contrary be geographically distributed, and the communications required between the elements for applying the steps indicated below are then applied via telecommunication links.

In embodiments, the screening application module 2 does not comprise any automatic preparation and analysis device.

The module for controlling the screening 3 for example comprises a microprocessor and a memory notably storing a program of software instructions. This program, when it is executed by the microprocessor, is suitable for applying the steps indicated below and being the responsibility of the control module 3. In an embodiment, it further includes a man-machine interface for example comprising a keyboard and a screen, in order to interact with an operator of the screening control module 3.

The communications interface 6 is adapted for remotely transmitting messages according to various remote transmission modes, depending on corresponding commands and on message contents sent by the screening control module 3.

For example, when the content of a message is provided by the screening control module 3, for example as electronic text, and the screening control module 3 orders that it be communicated through a phone call to a given telephone number, the communications interface 6 carries out a voice synthesis operation on the electronic text by means of a voice synthesizer, and vocally restores this text after having dialed the telephone number indicated by the screening control module 3 over a telephone network. When the contents of a message provided by the screening control module 3 is in the form of electronic text, and that the screening control module 3 orders that it be communicated via SMS to a given telephone number, the communications interface 6 elaborates an SMS and transmits it to the telephone number indicated by the screening control module 3. When the content of a message provided by the screening control module 3 is in the form of electronic text, and that the screening control module 3 orders that it be communicated to a given internet address, the communications interface 6 incorporates the text in an IP message and transmits it to the indicated internet address, etc.

The preparation and analysis automatic device 4 is a suitable automatic device for, from biological sample, notably cytological or even blood vials which are provided to it, carrying out automatically treatments comprising the preparation and the application of screening tests for one or several diseases on the samples, on the basis of parameterizations defined according to the sample to be analyzed.

In an embodiment, the automatic device 4 includes trays into which are inserted sample vials, bearing identification markings, for example of the barcode or RFID label type. It is adapted for extracting a sample from the taking from each vial, in order to deposit the sample in an analysis system of the biological (cell or molecular) type or of the cytological type, such as for example a decantation chamber, so that the sample is deposited as a cell smear to be analyzed, on an analysis slide positioned under the chamber, or for example an aliquot tube. Each cell sample selected in a tube or on the analysis slide also includes itself an identification marking. The automatic device 4 is adapted for, during the preparation of an analysis slide, reading, by reading means which are integrated to it, the identification marks on the sampling vial and on the analysis slide and/or the aliquot tube intended to receive the sample extracted from the sample-taking vial. The automatic device 4 is adapted for storing a correspondence, for example in the data base 5, between the identification marking of the analysis slide and the identification marking of the sample vial recorded in correspondence with the data of the patient from which stems the sample.

In an embodiment, the automatic device 4 is adapted for carrying out a pre-analytical control (for example measuring the cell density of the sample) and determining whether this sample includes a sufficient number of cells for obtaining a sufficient cell analysis, i.e. able to allow a reliable diagnostic (for example, for cytology of the uterine cervix, the Bethesda classification prescribes 5,000 cells per cell smear). In the opposite case, the automatic device 4 gives pre-analytical information of the sample, for example on cell density, and may enrich the sample by sampling more cells in the sample vial corresponding to the slide and by adding them into the decantation chamber above the slide, and plotting this secondary enrichment, or determining whether the sample is not sufficiently provided with cells and invalidating it.

In an embodiment, the automatic device 4 is adapted for determining, for achieving an analysis, a value indicating the quality of the sample depending on this pre-analytical control and for storing this value in the data base 5 in correspondence with the identification marking of the slide. In an embodiment, this value depends on the sufficient nature or not of the cell density initially present and/or on the achievement or not of an enrichment of the sample.

The automatic device 4 is also adapted for carrying out one or several tests on each analysis slide notably of molecular biology (genomic, proteomic, or other biology) and/or for carrying a cytological analysis of the contents of the slide by if necessary practicing additional biological techniques such as immuno-cytochemical studies or any other technique giving the possibility of showing biomarkers. In an embodiment, the automatic device 4 and/or an automatic device associated with a type of scanner digitizing the cytological smear slides carries out image capture of the contents of the slide, by means of image capture, and then applies image analysis algorithmic processing operations delivering a result characterizing the presence or not of the sought pathology, for example uterine cervix cancer. The automatic device 4 is then adapted for storing the result of the tests and analyses in the data base 5. The automatic device 4 is further adapted for recording in the data base 5 a confidence index on the result, determined during image analysis algorithmic processing operations or inputted by the practitioner supervising the analysis of the sample, as well as for example an identifier of the practitioner.

The automatic device 4 is for example of the type described in patent application EP 2 550 536 or in the application EP 2 198 259.

In an embodiment of the invention, with reference to FIG. 2, the following steps are applied, for example relating to screening of uterine cervix cancer.

In a step 100, during a visit of a patient to an entity, for example an administrative organization or a medical analysis laboratory associated with the screening application module 2, the coordinates of the patient are inputted by an operator of the screening control module 3, via the man-machine interface, and then are recorded by the screening control module 3 into the data base 5. The contact modes of the patient are recorded with the corresponding remote transmission coordinates. His/her preferred contact mode is further indicated.

Thus, if the contact mode is the telephone call or SMS, the telephone number of the patient will be stored in memory. When the contact mode is the sending of messages via social networks, the internet address of the patient will be stored in memory. When the contact mode is e-mail, at least one e-mail address of the patient will be stored in memory. When the contact mode is the indication of a third party, such as a physician, a social worker, a friend etc., remote transmission coordinates of the telephone number, e-mail address type etc. of the third party will be stored in memory.

Other pieces of information, hereafter called “additional data AD”, characterizing the patient are further inputted by the operator, and recorded by the screening control module 3, in respective fields of the data base 5. For example, among these additional data AD, appear:
his/her age or his/her date of birth; and/or
indication of risk factors exhibited by the patient for example of the hereditary type and/or history of the person; and/or
indication of vaccinations having been carried out by the patient, for example vaccination against uterine cervix cancer; and/or
data relating to the dates, and/or to the results, of one or several screening operations previously carried out by the patient; for example some of these data indicate whether a pathology was detected or not (generally, in properly followed-up populations, at least 5% of the tests detect an anomaly which may correspond either to an infectious condition or a temporary inflammatory condition, or to a pre-cancer or cancer condition which has to be monitored or treated in order to avoid the occurrence of an invasive carcinoma), and/or indicate a value, for example determined in pre-analytical control of an analysis slide and illustrating the quality of the sample used, and/or indicate a confidence level on the result of the screening; and/or
the date of one or previous messages for convening the patient to screenings, transmitted to the patient which may be of normal periodicity if no anomaly was detected or of an adapted periodicity or even a consultation and a treatment if an anomaly was detected, and optionally a copy of the transmitted contents.

It will be noted that some of these additional data may be inputted into the data base 5 during a first recording of the patient in the data base 5, while other ones of these additional data will be inputted gradually during events in connection with successive screenings included in a pre-established periodicity, for example providing result of analyses, or subsequently to visits of the patient to persons which may update the data base 5, for example during the subsequent visits of the patient to the analysis laboratory, or further to physicians or other entities allowed to carry out such updates in the data base 5.

This step 100 for a same patient may therefore be carried out in several times. This step 100 is further applied for each of a plurality of patients, among which notably the patients referenced as A and B in FIG. 1.

In a step 101, the screening control module 3 is adapted for automatically generating a message for convening a patient recorded in the data base 5.

In an embodiment, the generated message for convening the patient relates to a subsequent screening to be carried out by the patient.

The screening control module 3 is then adapted for extracting from the data base 5 the remote transmission coordinates corresponding to the preferred contact mode indicated for this patient and ordering to the communications interface 6, remote transmission to these remote transmission coordinates, of the generated convening message. The convening message is then remotely transmitted through the communications interface 6 to remote transmission coordinates. The patients A and B thus receive the convening messages which are intended for them according to their respective preferred contact mode, for example in an accessible e-mail messaging system on a computer 10_{A} via the internet network 100_{A} for patient A or via SMS on his/her portable telephone 10_{B} via a mobile telephone network 100_{B} for patient B.

According to the embodiments, the screening control module 3 determines, depending on one or several of the additional data AD mentioned above and relating to the patient, the contents of the convening message and/or the instant of remote transmission of said convening message.

For this, it applies for example predefined rules which depend on additional data AD, for example on the combination of some of these additional data.

For example, the remote transmission instant of a convening message for screening of uterine cervix cancer is calculated by the screening control module 3 notably depending on the date of the last screening for uterine cervix cancer carried out by the patient which indicated absence of a pathology.

In an embodiment, the periodicity of remote transmission of a message for convening a patient, for example telling him/her that a new screening for the disease is to be carried out, is determined depending on additional data AD, for example on a combination of some of these additional data.

In an embodiment, the contents of the convening message and/or the remote transmission instant of said convening message and/or the periodicity of remote transmission of a message for convening a patient is/are determined depending on recommendations issued from learned medical societies and/or national or international public organizations.

The periodicity is for example of a few months, of N years, with N being an integer.

As an illustration, the screening control module 3 is for example adapted for determining that a message for convening a patient to screening has to be remotely transmitted to a patient when she attains 30 years old, 35 years old and 40 years old, but a message for convening a screening will be sent at higher given respective frequencies for patients for which a quality value of a previous sample is less than a given threshold and/or a confidence index on the result of the previous screening is less than a given threshold and/or if the mother or grandmother of the patient had uterine cervix cancer of the adenocarcinoma type or a related pathology and/or if the patient was either vaccinated or not against uterine cervix cancer.

As another illustration, the screening control module 3 is adapted for, when the result of a sample carried out previously as stored in memory in the additional data AD indicates the existence of a pathology, generating a message for convening to extensive screening with the indication of additional tests to be carried out, determined by the screening control module 3 depending on the detected pathology.

As another illustration, the screening control module 3 is adapted for, when the result of a sample previously carried out as stored in memory in the additional data AD indicates the existence of a pathology, defining an additional test depending on this detected pathology, determining the address of the health organization(s) capable of conducting this additional test (optionally by only retaining the closest geographically to the patient) and for generating a convening message indicating the additional test to be conducted and further indicating the address of the determined health organizations. According to the embodiments, this convening message is to be sent within a given time after the date of the previous sampling as stored in memory in the additional data AD, or at a prescribed age of the patient or further at a date issued from the combination of several additional data recorded in the data base 5 according to the operating rules of the screening control module 3.

In an embodiment, a JAVA applet is remotely transmitted in the convening message, intended to be executed on the telephone, or on the computer, indicated as the addressee of the patient, and able to identify from the capable health organizations indicated in the message, those which are the closest geographically to the patient, depending on geolocalization data of the patient available from on the telephone (for example GPS data of the portable phone) or on the destination computer.

In an embodiment, the screening control module 3 is adapted for proposing a pre-analytical control and generating a message for convening at a time T (for example T=1 month) after a sampling, in the case when this sampling is insufficient for the initial analysis, intended for the patient, requiring a new cytological examination. In an embodiment, the screening control module 3 is adapted for proposing a pre-analytical control and generating a convening message at time T (for example T=1 month) after a sampling, in the case when this sample is insufficient for an additional molecular biology analysis, intended for the patient requiring a specific examination requiring a different material or cell preservation medium.

In an embodiment, the screening control module 3 is adapted for generating a convening message, the contents of which, for example in the case of a pathological test, orients the patient towards a specialized center where she may undergo the necessary diagnostic and/or prognosis examinations aimed at a close follow up (a horizon of 3 to 6 months, for example indicated in the initial convening message with convening reminders by regular messages before the required examinations) or of a specific, medical or surgical treatment.

In an embodiment, the screening control module 3 is adapted for sending the convening message to remote transmission coordinates of the patient other than those of the preferred contact mode of the patient, optionally in addition to the transmission according to the preferred contact mode, when it determines according to the additional data AD relative to the date of the last sent convening message and to the date of the last screening carried out, that no screening took place for the patient following the sending of the last convening message.

In an embodiment, the rules may further be updated depending on the time-dependent changes in the recommendations by the learned societies.

In an embodiment, the behavior of the patients from the data base 5, in reaction to convening messages may be analyzed and modeled so as to update the determination rules, by the screening control module 3 and on the basis of the additional data AD relating to the patients, of the contents of the convening messages and/or on the remote transmission instant of the convening messages.

In an embodiment, in a step 102, a vial having an identification marking and including a smear from the uterine cervix of a patient, patient 10_{A} for example, is provided to the automatic device 4 for analyzing the sampled smear. In the data base 5, the identification marking appearing on the vial is recorded in correspondence with the other data of the data base 5 relating to the patient.

The automatic device 4 then applies the steps for preparing and analyzing the sample in the vial indicated above. It reads the identification marking of the vial, determines in the data base 5, the patient depending on the read marking and records in the additional data AD relating to the patient, the determined quality value of the sample, and then the result of the cytological analysis and if necessary, of additional biology techniques and the confidence index on the result.

In an embodiment, the automatic device 4 is further adapted for customizing processing operations which it carries out depending on at least some of said additional data AD and recorded for the patient in the data base 5 or of a function combining some of these additional data.

For example, in an embodiment, it adapts the minimum number of cells during the pre-analytical control step, for example depending on the comparison of the confidence index of the result of a previous sample with a given threshold.

In an embodiment, it is adapted for carrying out dual sampling straightway, and then respectively conducting molecular biology and cytological tests (“co-testing”) and/or for carrying out a first sampling followed by HPV “reflex-testing” on this first sample (“cytological screening”) or the reverse (“HPV primary screening”), or a second sampling in the case of a first insufficient sample.

Step 102 is optional. Further, in FIG. 2, it is indicated as posterior to step 101, but it may be before the latter.

Moreover, it will be noted that in another embodiment, steps for recording into the data base 5, additional data AD relating to a patient, indicated above as carried out by the automatic device 4, are carried out by the screening control module 3, subsequent to provision of said additional data by the automatic device 4 to the control module 3.

In the example having received comments above with reference to FIG. 2, the example of the uterine cervix cancer was considered. Nevertheless, the invention may be applied for screening any other type of disease by sampling, for example prostate, bladder, breast, thyroid, lung cancer etc.

In an embodiment, a same data base 5 may be inputted by several entities, for example by several analysis laboratories, physicians etc., by means of the data relating to their respective patients, with if necessary the setting into place of validation mechanisms before recording, of the various additional data completed in the data base.

In an embodiment, analysis laboratories each comprise a module for applying screening, either comprising or not an automatic device for preparation and analysis 4. The organization of the screening is then ensured locally at the analysis laboratory.

The invention gives the possibility of improving the screening of disease(s), notably by increasing observance of the recommended frequency of the screening operations and by customizing the convenings depending on the individuals, on the elements of their medical history, and/or on scientific recommendations related to the screening and/or geographic locations. Thus, an optimized screening is applied, adapted to the time-dependent changes in the practices and techniques of the proposed examinations and thereby contributing to reducing the effects of the disease, notably the mortality rate which is associated therewith, and to reducing costs in terms of public health.

It will be noted that a disease-screening operation according to the invention notably gives the possibility of organizing massive screening and of sending messages for convening a population of healthy individuals (i.e. considered as not having caught the disease and which are not the subject of any treatment of this disease).

1. A disease-screening method by sampling on an individual, said method being applied by a module for applying screening and comprising the following steps:
storing in a data base of said screening application module, of a set of data relating to an individual, said set of data comprising remote transmission coordinates relating to said individual, and additional data relating to said individual from among the age of the individual and/or data relating to the date and/or to the result of at least one previous screening relating to said individual and/or data relating to risk factors associated with said individual and/or data relating to a vaccination of said individual;
remote transmission by said screening application module, of said remote transmission coordinates relating to said individual, of a message for convening the individual to a subsequent screening to be carried out by said individual, said screening application module further determining, depending on at least said additional data relating to said individual, the contents of said convening message and/or the remote transmission instant of said convening message.

2. The disease-screening method according to claim 1, wherein said additional data comprise an indicator of the quality of a sample used for a previous screening carried out by said individual.

3. The disease-screening method according to claim 1, wherein said additional data comprise a confidence index associated with the result of a previous screening carried out by said individual.

4. The disease-screening method according to claim 1, wherein the contents of said convening message is determined depending on the geographic localization of said individual.

5. The disease-screening method according to claim 1, wherein at least one test to be conducted during said subsequent screening is defined by said screening application module, depending on at least said additional data relating to said individual.

6. The disease-screening method according to claim 1, wherein said screening is a screening for pre-cancer or cancer lesions with a type of cytology or cell molecular biology analysis.

7. A module for applying screening for diseases by sampling on an individual, comprising
a data base configured to store a set of data relating to an individual and comprising remote transmission coordinates relating to said individual, and additional data relating to said individual from among the age of the individual and/or data relating to the date and/or to the result of at least one previous screening relating to said individual and/or data relating to risk factors associated with said individual and/or data relating to a vaccination of said individual;
a remote transmission block configured to remotely transmit to remote transmission coordinates relating to an individual and stored in the data base, a message for convening the individual to a subsequent screening to be carried out by said individual,
said screening application module being adapted so as to determine, depending on at least said additional data relating to said individual, the contents of said convening message and/or the remote transmission instant of said convening message.

8. The screening application module according to claim 7, wherein said additional data comprise an indicator of the quality of a sample used for a previous screening carried out by said individual.

9. The screening application module according to claim 7, wherein said additional data comprise a confidence index associated with the result of a previous screening carried out by said individual.

10. The screening application module according to claim 7, adapted for determining the contents of said convening message depending on the geographical localization of said individual.

11. The screening application module according to claim 7 adapted for defining at least one test to be conducted during said subsequent screening depending on at least said additional data relating to said individual.

12. The disease-screening method according to claim 7, wherein said screening is a screening for pre-cancer or cancer lesions of the type of cytology or cell or molecular biology analysis.

13. A non-transitory computer-readable medium including a computer program configured to be-installed in a module configured to disease-screen by sampling on an individual, said program comprising instructions for applying the method according to claim 1 upon executing the program with a processor of said screening application module.
